(19) United States
(12) Patent Application Publication
(10) Pub. No.: US 2014/0112783 A1
(43) Pub. Date: Apr. 24, 2014

(54) HORIZONTAL AXIS MULTIPLE STAGES WIND TURBINE

(71) Applicant: Mario Caggiano, Montreal (CA)

(72) Inventor: Mario Caggiano, Montreal (CA)

(73) Assignee: 7142871 Canada, Inc., Montreal (CA)

(21) Appl. No.: 14/118,101

(22) PCT Filed: Jul. 6, 2012
(86) PCT No.: PCT/IB2012/001337

§ 371 Date: Dec. 13, 2013

Related U.S. Application Data
(60) Provisional application No. 61/505,506, filed on Jul. 7, 2011.

(51) Int. Cl. F03D 3/02

(52) U.S. Cl. CPC F03D 3/02
USPC 416/126

(57) ABSTRACT

An HMSWT is disclosed which is constructed of successive cage type turbine assemblies. The multiple turbine assemblies are preferably induced into a reverse rotational movement from one another in a coupling effect. A first turbine assembly is propelled and forced into a rotational movement propelled by the oncoming wind which in turn induces a second, inner turbine assembly to rotate in an opposite and reverse direction. This coupling effect enables the rotational movement of two or more turbines with the same oncoming wind and airflow. The particular design of these multiple blades not only enhance the propelling force of the wind by increasing rotational movement, but simultaneously redirects the same airflow inward increasing the velocity of the airflow and propelling it onto the inner turbine assembly.

### CROSS-REFERENCE TO RELATED APPLICATION

The present application claims priority to and incorporates herein by reference U.S. Provisional Patent Application Ser. No. 61/505,506, filed on Jul. 7, 2011.

### BACKGROUND OF THE INVENTION

A windmill is a machine which converts the energy of wind into rotational energy by means of vanes called sails or blades. The windmill has been used for hundreds of years as a way to harness the earth's power and transform this mechanical movement in order to do work. Wind power has been used as long as humans have put sails into the wind. For more than two millennia wind-powered machines have ground grain and pumped water. In the course of history the windmill was adapted to many other industrial uses. An important non-milling use is to pump groundwater up with wind pumps, commonly known as wind wheels. Wind-powered pumps drained the polders of the Netherlands, and in arid regions such as the American mid-west or the Australian outback, wind pumps provided water for live stock and steam engines.

With the development of electric power, wind power found new applications in lighting buildings remote from centrally-generated power. Throughout the 20th century small wind plants suitable for farms or residences were developed, and larger utility-scale wind generators were also constructed that could be connected to electricity grids for remote use of power. Windmills used for generating electricity are commonly known as wind turbines. In modern times the wind has been harnessed to create mechanical power to produce electricity with many more alternate applications. Windmills are essentially fans in reverse; instead of using the electricity to make wind for ventilation, they use wind to create mechanical power to in turn produce electricity.

Today wind powered generators operate in every size range from small units and up to near-gigawatt sized offshore wind farms that provide electricity to national electrical networks. The idea behind it is simple and time-tested. Wind turns the blades of the windmill which in turn, turns a shaft. The shaft turns a gearbox that turns a generator. The larger the windmill, the more efficient it is and the more energy it produces. These wind turbines are very useful because they work wherever there are decent levels of wind. This means that any remote weather stations, water pumping stations, remote electrical stations and farms to name a few applications, can be powered by one or a series of wind turbines. Hybrid systems have been developed as well, that use wind turbines in conjunction with diesel generators, solar cells, and battery packs in order to deliver a more consistent source of power.

However, conventional wind turbines and present construction designs have serious operational limitations which hamper their performance capabilities and power output range. Some of the disadvantages are related to the operational strength of the wind which at times is not constant and varies from zero to storm force. This means that conventional wind turbines do not produce the same amount of electricity all the time. In general with most conventional HWAT or VWAT wind turbines, the head winds have to be at least 17 mph strong to make the blades spin and thus produce energy. There will be times when they produce no electricity at all. Large wind machines have to be shutdown if the wind is too strong, to avoid damage because they cannot exceed a certain rotational speed.

The conventional designs and present blade construction cannot withstand excessive rotational forces such as torsion and high tension directly associated with high rotational speeds. Unfortunately, increased energy and electrical production is directly to and absolutely require high rotational speeds. The only practical way to produce large amounts of power is to use hundreds of them in an array in a place where the wind is most constant, such as floating on platforms out to sea, as is being done in various regions of the world. The enormous size and wing or blade span is also another huge disadvantage of these conventional wind turbine designs.

### BRIEF SUMMARY OF THE INVENTION

An embodiment of the present invention includes a multiple stage turbine comprising: a first cylindrical turbine assembly having a plurality of blades positioned longitudinally around a circumference of the first turbine assembly; a second cylindrical turbine assembly having a plurality of blades positioned longitudinally around a circumference of the second turbine assembly, said inner second cylindrical turbine assembly extending longitudinally within the first cylindrical turbine assembly; wherein the blades of the first turbine assembly are shaped, positioned and angled to cause rotation of the first turbine assembly in a first direction when exposed to airflow, and to channel the airflow inward toward the second cylindrical turbine assembly; and where the blades of the second turbine assembly are shaped, positioned and angled to cause rotation of the second turbine assembly in a second direction which is opposite the first direction when exposed to the airflow.

According to the broad aspect of an embodiment of the present invention, there is provided a Horizontal Multiple Stages Wind Turbine (“HMSWT”). One embodiment of the present invention relates to a revolutionary new concept and design which uses the wind's natural kinetic energy to create a rotational movement which is in turn transformed into mechanical energy and generation of electrical power. The HMSWT preferably incorporates a revolutionary turbine assembly blade design and construction, innovative system functionality using aeronautical principles in blade design and coupling effect as part of a multiple turbine blade assemblies within the HMSWT.

However, it will be explained and understood that the transformation of this kinetic energy from the wind creating rotational movement and mechanical energy into electrical energy is achieved by means of power generating components and accessories. As a non-limiting example, such accessories and components may include: multiple turbine assemblies connected to independent shafts which are in turn connected to permanent magnetic alternators or generators which create three phase AC or alternative current power. This electrical power may then be rectified to DC or direct current in order to charge large power storage batteries or feed a grid-synchronous inverter.

An enormous advantage of the HMSWT is its turbine blade design and the multiple turbine assemblies which are preferably induced into a reverse rotational movement from one another in a coupling effect. To better explain the operational capability and advantages of this new innovative system one must understand the relationship and interaction between the multiple turbine assemblies. An outer turbine assembly is propelled and forced into a rotational movement propelled by the oncoming wind which in turn induces the second and inner turbine assembly to rotate in an opposite and reverse direction. This effect—called the coupling effect—enables the rotational movement of two or more turbines with the same oncoming wind and airflow. This effect is created by the multiple blades constructed within each of the turbine assemblies. The particular design of these multiple blades not only enhance the propelling force of the wind by increasing rotational movement but simultaneously these blades redirect the same airflow inward increasing the velocity of the airflow and propelling it onto the inner turbine assembly.

The multiple blades of the inner turbine assembly are preferably positioned in reverse configuration from the outer turbine assembly as discussed below, allowing them to receive this high velocity airflow which then induces and forces a reverse and opposite rotational movement. Subsequently, a turbine assembly rotates in a reverse rotational direction from a turbine assembly positioned immediately to its inside or outside. This process can be repeated in the case where more than two turbine assemblies are constructed within the HMSWT.

In the preferred embodiment, the HMSWT will be constructed with two turbine assemblies: a primary outer turbine assembly and a secondary inner turbine assembly. In an alternate embodiment, the HMSWT may be comprised of a multiple of turbine assemblies such as three or more. The HMSWT can be constructed in various sizes which directly affect output range and electrical power production. Thus, the overall size of the HMSWT may and will vary also according to the number and size of the turbine assemblies.

This innovative new design and advanced operational concept enables for increased rotational speeds which directly increases the electrical power production capabilities. The advanced blade design construction of each of the multiple blade turbine assemblies are designed to accentuate rotational movement while simultaneously siphoning and propelling the oncoming airflow at a higher velocity inward. Each turbine assembly is constructed in a reverse configuration from the previous and/or subsequent turbine assembly. Therefore, it must be understood that the rotational movement of one turbine assembly induces the reverse rotational movement of the other turbine assembly and so on.

This entirely new technological and innovative concept provides for increased strength and sturdiness, more compact design and construction while simultaneously achieving increased rotational speeds which directly translates into greater production capabilities of electrical energy. This new design incorporating advanced aeronautical blade construction, does not compromise on power output but rather greatly increases operational efficiency and electrical power generation through its capability of operating in adverse conditions with high head winds causing high rotational speeds.

The HMSWT turbine assemblies' blade design and coupling effect concept will be able to produce greater electrical power output with the same oncoming wind as compared to the conventional wind turbines and will be capable of operating in variable, strong or moderate wind conditions as well as in nonexistent wind conditions. The HMSWT operational capabilities of achieving and sustaining high rotational speeds due to its construction and the coupling effect of the multiple outer and inner turbines enable this new wind turbine concept to produce greater electrical power generation and output. The design innovation may also include and utilize reverse magnetic propulsion to provide a minimum rotational movement in order to enable electrical power production even in the absence of wind.

Other objects, features, and advantages of the present invention will become apparent with reference to the drawings and detailed description that follow.

### BRIEF DESCRIPTION OF THE SEVERAL VIEWS OF THE DRAWING

The embodiments of the present invention shall be more clearly understood by making reference to the following detailed description of the embodiments of the invention taken in conjunction with the following accompanying drawings which are described as follows;

FIG. 1A is a partially exploded perspective view of an HMSWT with two turbine assemblies according to an embodiment of the invention.

FIG. 1B is a partially exploded perspective view of an HMSWT with three turbine assemblies according to an embodiment of the invention.

FIG. 2 is a cross-sectional view of the HMSWT of FIG. 1A.

FIG. 3 is a partially exploded perspective view of the HMSWT of FIG. 1A, also illustrating internal components of the base assembly.

FIG. 4 is a schematic airflow diagram in top plan view showing turbine blades arranged in an alternating pattern.

FIG. 5A is an airflow diagram of an unslotted blade in cross-section.

FIG. 5B is an airflow diagram of a turbine blade with a leading edge slat and trailing edge winglet in cross-section.

FIG. 5C is an airflow diagram of a turbine blade with a leading edge slot and trailing edge winglet in cross-section.

FIG. 6A is a cross-sectional airflow diagram of primary and secondary turbine blades arranged according to an embodiment of the present invention.

FIG. 6B is a cross-sectional view of one example of a turbine blade.

FIG. 7 is a cross-sectional view of the inner construction of an HMSWT alternate embodiment for the primary outer turbine assembly including interaction with the airflow as it is siphoned by the blade design.

It should be understood that the present drawings are not necessarily to scale and that the embodiments disclosed herein are sometimes illustrated by fragmentary views. In certain instances, details which are not necessary for an understanding of the present invention or which render other details difficult to perceive may have been omitted. It should also be understood that the invention is not necessarily limited to the particular embodiments illustrated herein. Like numbers utilized throughout the various figures designate like or similar parts or structure.

### DETAILED DESCRIPTION OF THE INVENTION

The present invention relates to a Horizontal Rotational design of Multiple

Stages Wind Turbine (“HMSWT”). This revolutionary concept and design uses the wind's natural kinetic energy to create a rotational movement which is in turn transformed into mechanical energy and generation of electrical power. It will be explained and understood that the transformation of this kinetic energy from the wind creating rotational movement and mechanical energy into electrical energy is achieved by means of power generating components and accessories such as: multiple turbine assemblies connected to independent shafts which are in turn connected to permanent magnetic alternators which create three phase AC power. This electrical power is then preferably rectified to DC or direct current in order to charge large power storage batteries or feed a grid-synchronous inverter.

In a preferred embodiment, the turbine blade assemblies may be connected directly to one or several alternators via one or multiple shafts which eliminate the use of gearboxes. However, in an alternate embodiment, the HMSWT design may incorporate multiple gearboxes, one for every turbine assembly, in order to increase the alternator's speed in the case where the turbine assemblies are rotating slower.

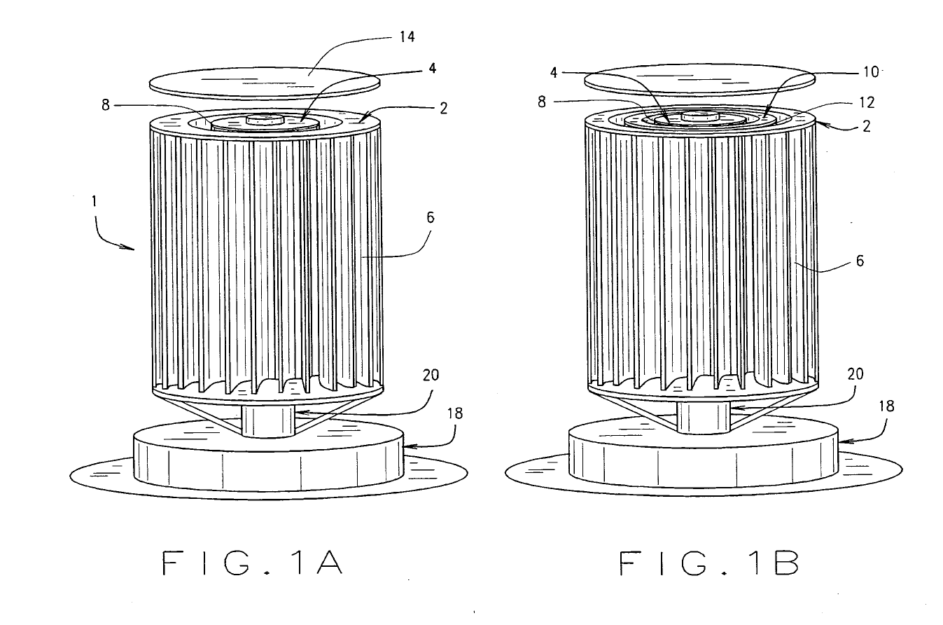

As shown in FIGS. 1A, 2 and 3, in a preferred embodiment, the HMSWT 1 incorporates two turbine assemblies: a primary outer turbine assembly 2 and a secondary inner turbine assembly 4. Primary turbine assembly 2 includes outer blades 6, while secondary turbine assembly 4 includes inner blades 8. However, in an alternate embodiment as shown in FIG. 1B, an HMSWT la may incorporate a tertiary mid turbine assembly 10 having mid blades 12. For ease of reference, HMSWT 1 with only two turbine assemblies 2, 4 will be discussed hereinafter unless otherwise noted.

As can be seen in FIG. 1A, HMSWT 1 includes a ceiling 14, a base 18 and a rotational housing 20. In operation, wind enters the outer turbine assembly 2, causing it to spin. The blades 6 of outer turbine assembly 2 channel the wind into the inner turbine assembly 4, causing it to spin in the opposite direction of outer turbine assembly 2. In HMSWT 1a of FIG. 1B, the outer turbine assembly 2 channels the wind to mid turbine assembly 10, causing the mid turbine assembly 10 to rotate in a direction opposite the outer turbine assembly 2. The blades 12 of the mid turbine assembly 10 channel the wind to the inner turbine assembly 4, causing the inner turbine assembly 4 to rotate in a direction opposite the mid turbine assembly 10. Thus, in HMSWT 1a, the outer turbine assembly 2 and the inner turbine assembly 4 rotate in the same direction, which is opposite the direction of rotation of the mid turbine assembly 10.

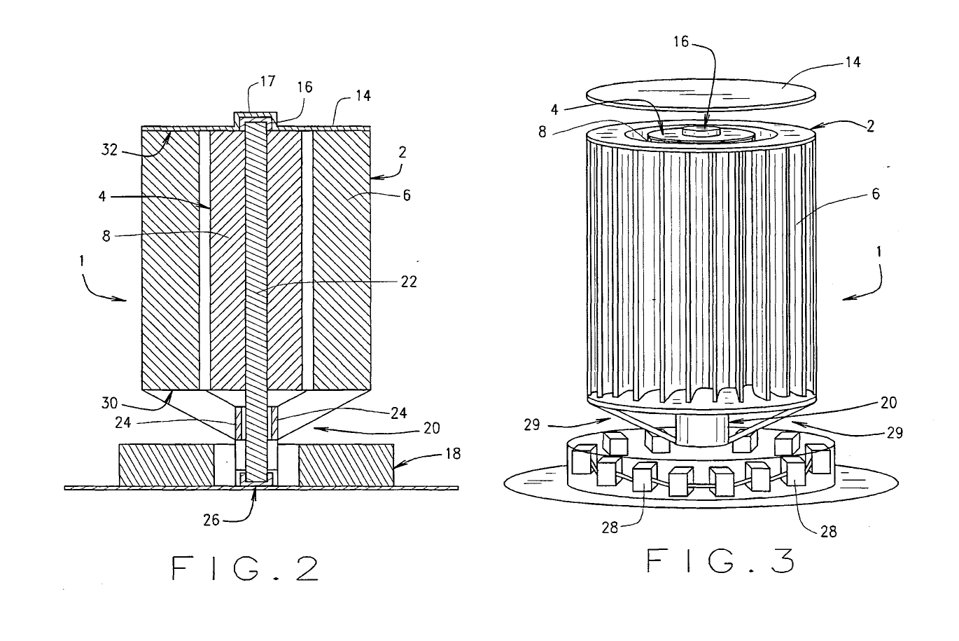

FIG. 2 illustrates a cross-sectional view of HMSWT 1, illustrating the relationship between outer turbine assembly 2 and inner turbine assembly 4. Preferably, the inner turbine assembly 4 is connected to an inner shaft 22, while the outer turbine assembly 2 is connected to an outer shaft 24. Outer shaft 24 is preferably hollow, such that inner shaft 22 can rotate independently therein. Inclusion of a mid turbine assembly 10 would preferably also include a third, hollow mid shaft (not shown) which rotates independently of shafts 22, 24. Inner shaft 22 may also be hollow.

The outer shaft 24 preferably resides within rotational housing 20, and preferably extends down to and sits within lower coupling 26 located in base 18. The inner shaft 22 preferably extends through the hollow portion of outer shaft 24, and extends upward from the base 18 to the top of the HMSWT 1 where it inserts and joins into a top coupling 16. This top coupling 16 is then fitted into a ceiling coupling 17 located in the ceiling 14 of HMSWT 1. This ceiling coupling 17 is preferably wider in diameter than the top coupling 16.

In one embodiment, top coupling is 16 is constructed with internal roller bearings located within the sidewalls of top coupling 17 so as to allow the inner shaft 22 to rotate about its longitudinal axis therein, and provide for a tight fit and low spacing tolerance between the inner shaft 22 and the roller bearings within the top coupling 16. This construction allows for stability during rotational operation without permitting material vibrations. Subsequently, the tightly fitted top coupling 16 is inserted into the wider ceiling coupling 17, which provides for lateral stability and sturdiness not only for the inner turbine assembly 4 but also the outer turbine assembly 2 and the entire HMSWT 1 structure. Additionally or in the alternative, ceiling coupling 17 may include roller bearings in its side wall.

Once the HMSWT1 is assembled and parts are fitted into each other this amalgamation of all the components provides total structural strength. The HMSWT 1 concept is therefore more sturdy and reliable due to its design which can withstand greater frontal and operational forces imposed by high incoming winds such as; torsion, stress, and strain. This design can withstand much greater airflow pressures and thus achieve substantially higher operational capabilities as compared to standard HAWT horizontal or VAWT vertical air wind turbines. Consequently, the HMSWT 1 concept can achieve a higher rotational speed which directly affects and increases electrical output and consequently increasing power production. In another alternate embodiment, the outer turbine assembly 2 and inner turbine assembly 4 are separately mounted.

In a preferred embodiment, in addition to wind providing the rotational movement of the HMSWT 1, there may also incorporate magnetic assemblies located in or proximate ceiling 14 (not shown) and/or base 18 (as shown in FIG. 3). Industrial magnets 28 may be installed in a reverse polarity configuration to assist in the rotation of the turbine assemblies 2, 4 even in the absence of or presence of weak oncoming winds. Corresponding magnetic modules 29 are also preferably mounted to the upper (not shown) and/or the lower portion of the turbine assemblies 2, 4 or the housing therearound. A combination of both wind and reverse magnetism can thereby create a continuous propelling force and motion which constantly rotates the HMSWT 1.

During operation, the magnetic modules 28, 29 installed both in base 18 and on the rotating turbine assemblies 2, 4 are in close proximity to one another and are of inversed polarity creating a strong repulsion resulting in a rotational force. The design and positioning of these magnetic modules 28, 29 will direct the rotational movement of the turbine assemblies 2, 4 that are being propelled clockwise and counterclockwise according to the blade configuration of the particular turbine assembly 2, 4.

Each of these turbine assemblies 2, 4 and 10 may be independently connected to separate magnetic generators by means of rotating shafts and gear assemblies, producing varied intensities of power output according to their rotational speed and cycles. Due to the installation of these magnetic leads located on the rotating turbine assemblies and the fixed HMSWT 1 structure housing, the rotational movement creates electricity as they come in close proximity. The magnetic polarity created by the rotors on the rotating turbine assemblies 2, 4 and 10 and stators part of the magnetic generators located in the base 18 produce electrical energy and power.

In one embodiment, the outer turbine assembly 2 is supported on and rotates around upper and lower track and bearing assemblies 30, 32. These track and bearings assemblies 30, 32 allow for lateral stability without limiting rotational movement and speed. The track and bearings assemblies are structured as would be understood by one of ordinary skill in the art, and preferably include bearings mounted around a track (not shown). Whereas shaft 22 allows the inner turbine assembly 4 to rotate, the track and bearing assemblies 30, 32 allow the outer turbine assembly 2 to freely rotate. In an alternative embodiment, both or all of the turbine assemblies 2, 4 may be mounted on track and bearing 30, 32. In another alternative, one or more of the turbine assemblies 2, 4, 10 may sit on a magnetic air cushion created by magnetic modules 28, 29. This would provide not only the propelling force, but simultaneously the above discussed cushion of air.

HMSWT 1 may incorporate blades 6, 8 having a variable blade pitch design. As discussed above, the design and rotational movement of the outer turbine assembly 2 draws airflow inward while simultaneously thrusting the airflow toward the inner turbine assembly 4 and increasing its velocity and pressure. This airflow then forces the reverse rotational movement of the inner turbine assembly 4. In order to create this reverse rotation, in a preferred embodiment the blades 6, 8 within the turbine assemblies 2, 4 are fixed position blades with an accentuated important curvature.

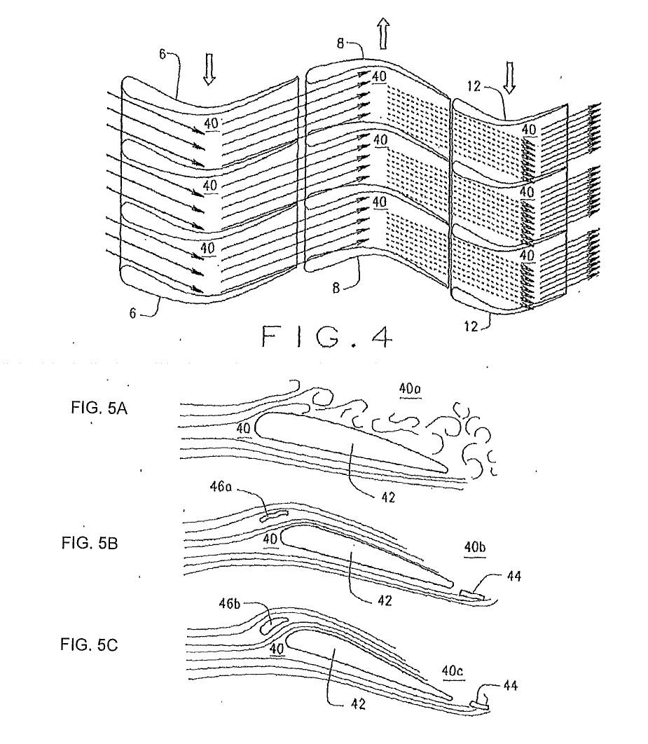

An exemplary shape and orientation of blades 6, 8 and 12 is shown in FIG. 4. As will be understood, such blades 6, 8 and 12 are shown in FIG. 4 as being substantially linear with one another for ease of explanation, although as installed in turbine assemblies 2, 4 and 10, such blades 6, 8 and 12 would be configured in concentric rings. The shape and orientation of these blades 6, 8 and 12 not only creates rotational movement but also thrusts airflow 40 inward toward subsequent turbine assemblies to cause the reverse rotation thereof. The turbine assemblies' 2, 4, 10 multiple blade design generates a strong rotational movement while at the same time creating a funneling effect moving the airflow inward increasing its velocity and pressure. The blade 6, 8 and 12 and camber design of these turbine assemblies 2, 4 and 10 is such that upon receiving the incoming airflow 40, this airflow 40 is then guided, siphoned and redirected inwardly while simultaneously increasing the velocity and pressure of airflow 40. This airflow 40 then travels inward coming in contact with the blades 8 of the inner turbine assembly 4 or, in the alternate embodiment, a mid turbine assembly 10, creating opposite rotational thrust and movement thereof.

As shown in FIGS. 5B and 5C, in one embodiment, the blades 6, 8 and 12 may be designed with a variable leading edge slat 46a or slot winglet 46b, and/or a trailing edge winglet 44. Such slats 46a, slots 46b and winglets 44 improve the laminar flow and direction of the airstream across the blades 6, 8 and 12 in order to reduce turbulence, vibration and drag 40a, especially at high rotational speeds, resulting in greater rotational thrust capabilities of each turbine assembly 2, 4 and 10 which translates in increased power generation.

Therefore, in an embodiment including at least three turbine assemblies, the design and orientation of blades 6 cause airflow 40 to be propelled at a high pressure inward by the outer turbine assembly 2 spinning in a direction, inducing and forcing the mid turbine assembly 10 to rotate in an opposite direction. In turn, the mid turbine assembly 10 then repeats this process, inducing and forcing the airflow 40 into the inner turbine assembly 4 and causing it to rotate in a direction opposite the mid turbine assembly 10 and the same as the outer turbine assembly 2. This induced rotational process and reversed coupling effect allows for these multiple stages of turbine assemblies to operate simultaneously but in opposite rotational direction from any subsequent and preceding turbine assemblies, generating tremendous force and pressure which translates into motion which can then be harnessed and transformed into energy and electrical power.

In a preferred embodiment, the blades 6, 8 and 12 and turbine assemblies 2, 4 and 10 may be constructed of aluminum, titanium, carbon fibers, or any combination of alloys and materials which best provide high tensile strength, durability, light weight and resistance to the elements. This increases performance capabilities according to the operational environment in which the HMSWT 1 would be installed. The construction materials used for the blades 6, 8 and 12 and the turbine assemblies 2, 4 and 10 are preferably be capable of handling sustained high incoming airflow pressures and accommodate increased rotational speeds. As will be understood, construction specifications and materials which will be used will be dependent on the operational as well as on site environmental conditions in which the HMSWT 1 will be exposed to and functioning in. In a preferred embodiment, the metal of choice used in the construction of the turbine blades 6, 8 and 12 and assemblies 2, 4 and 10 is aluminum alloy and/or composite materials and/or wood in order to provide sturdiness and lightweight construction. The number of blades 6, 8 and 12 within the turbine assemblies 2, 4 and 10, their size, thickness, camber and depth may vary according to the diameter, size and power output range and specific operational design requirements of the HMSWT 1.

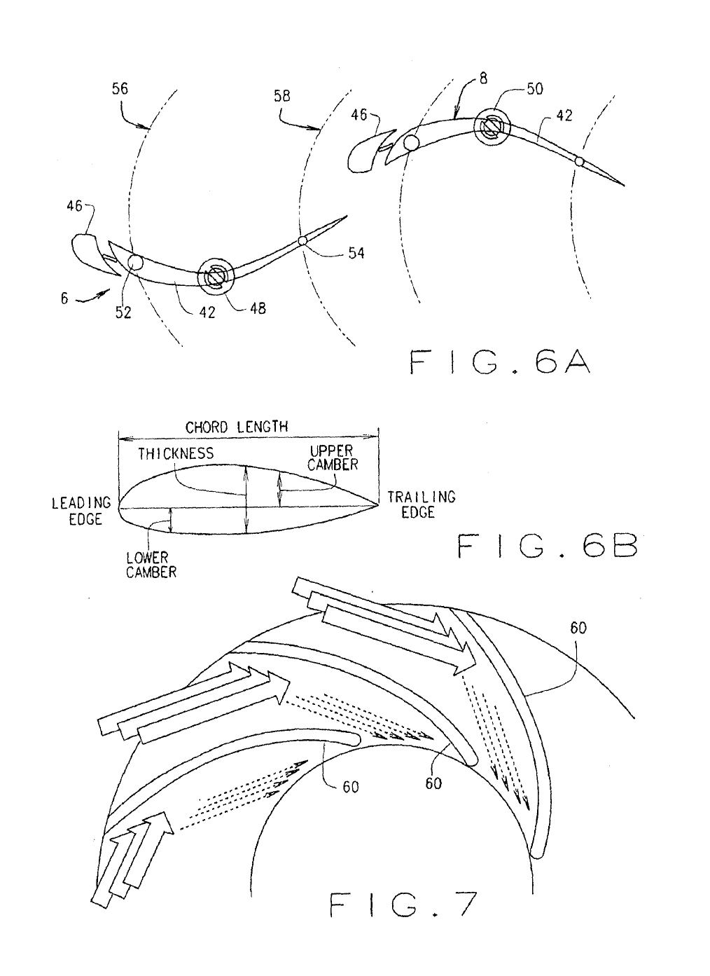

The environmental conditions and operational location in which the HMSWT 1 will be adapted to and functioning in will also determine the design parameters and unit specifications. In a preferred embodiment, the blade and camber design of the multiple turbine assemblies will resemble an aeronautical wing design having a streamlined yet accentuate curvature of the upper and lower camber as well as the thickness of the wing, as seen in FIG. 6B, in order to enhance and accelerate the airflow movement rearward. Preferably, a blade is rounded at its leading edge and widens to have a camber thickness which is larger near the front of the blade and narrows down to a relatively sharp trailing edge, as shown in FIG. 6B. Generally, a blade preferably has an upper camber which is greater in thickness than its lower camber.

As seen in FIG. 6A, each turbine assembly 2, 4 and 10 may include pivoting rings 56 and 58 located horizontally at either or both of the top and bottom of the turbine assembly. Leading and/or trailing edges of the blades 6, 8 or 12 may be connected to the pivoting rings 56 and 58 at points 52 and 54, respectively. Additionally or in the alternative, blades 6, 8 or 12 may each be connected to pivoting bearing assembly 48, 50. The pivoting rings 56, 58 and/or the pivoting bearing assemblies 48, 50 may be used to pivot the blades 6, 8 and 12 and adjust their pitch. The pivoting rings 56, 58 and/or the pivoting bearing assemblies 48, 50 may link blades 6 or 8 or 12 together for simultaneous adjustment of blade pitch in each respective turbine assembly 2, 4 and 10 separately from the other turbine assemblies 2, 4 and 10. A motor (not shown) as would be understood in the art may be utilized to rotate the blades 6, 8 and 12.

The blade design will also promote and maintain linear airflow to avoid turbulence and restriction in efficiency. The design of both the upper and lower camber sections of the blade design (seen in FIG. 6B) as well as the positioning of the blades within the same turbine assembly in relation to one another will compress and concentrate the airflow as it moves rearward creating higher velocity and static pressure.

In an alternative embodiment as seen in FIG. 7, a turbine assembly may have similarities to an impeller. An impeller design receives the airflow and then inducing this airflow by creating a vacuum that siphons this airflow and increasing both its velocity and pressure. In this alternate embodiment, the design of the thickness, and upper and lower camber width of blades 60 may be diminished and highly streamlined making it much thinner in construction. In this design configuration, the positioning of the blades 60 in relation to each other within the turbine assembly is such that airflow is received and velocity is increased as it travels rearward.

Although the foregoing description and accompanying drawings relate to specific preferred and alternate embodiments of the present invention and specific methods of wind power generation and regeneration as well as various wing configurations and design systems as presently contemplated by the inventor, it will be understood that various modifications, changes and adaptations, may be made without departing in any way from the spirit of the invention.

what is claimed is:

1. A multiple stage turbine comprising:
a first cylindrical turbine assembly having a plurality of blades positioned longitudinally around a circumference of the first turbine assembly;
a second cylindrical turbine assembly having a plurality of blades positioned longitudinally around a circumference of the second turbine assembly, said inner second cylindrical turbine assembly extending longitudinally within the first cylindrical turbine assembly;
wherein the blades of the first turbine assembly are shaped, positioned and angled to cause rotation of the first turbine assembly in a first direction when exposed to airflow, and to channel the airflow inward toward the second cylindrical turbine assembly;
and where the blades of the second turbine assembly are shaped, positioned and angled to cause rotation of the second turbine assembly in a second direction which is opposite the first direction when exposed to the airflow.

2. The turbine assembly of claim 1, further including:
a third cylindrical turbine assembly having a plurality of blades positioned longitudinally around a circumference of the third turbine assembly, said third cylindrical turbine assembly extending within the second turbine assembly;
wherein the blades of the second turbine assembly are shaped, positioned and angled to further channel the airflow inward toward the third cylindrical turbine assembly; and
wherein the blades of the third turbine assembly are shaped, positioned and angled to cause rotation of the third turbine assembly in the first direction when exposed to the airflow.

3. The turbine assembly of claim 1 wherein a pitch of the blades of at least one of the turbine assemblies is adjustable by rotating the blades.

4. The turbine assembly of 3, further including a motor for selectively rotating the blades.

5. The turbine assembly of claim 3, further including at least one pivoting bearing assembly, each pivoting bearing assembly being connected to a respective blade.

6. The turbine assembly of claim 3, further including at least one pivoting ring for assisting in adjusting the pitch of the blades.

7. The turbine assembly of claim 6 wherein a plurality of blades on a respective turbine assembly are pivotably attached to at least one of said pivoting rings for simultaneous adjustment of blades in said turbine assembly.

8. The turbine assembly of claim 1 wherein the blades of at least one of the turbine assemblies include leading edge slats or slots, and a trailing edge winglet.

9. The turbine assembly of claim 8 wherein the leading edge slats or slots and the trailing edge winglet have positions which are adjustable relative to the blade.

10. The turbine assembly of claim 1 wherein the second turbine assembly is connected to and rotates a shaft, and wherein the first turbine assembly is connected to and rotates a hollow cylinder, said shaft extending longitudinally within the hollow cylinder.

11. The turbine assembly of claim 10 wherein the hollow cylinder and shaft rotate independently from each other.

12. The turbine assembly of claim 1 wherein the blades are curved.

13. The turbine assembly of claim 12 wherein the blades of the first turbine assembly are curved in a first direction and the blades of the second turbine assembly are curved in a different direction.

14. The turbine assembly of claim 1 wherein a blade is rounded at the leading edge and widens to have a camber thickness which is larger near the front of the blade and narrows down to a relatively sharp trailing edge.

15. The turbine assembly of claim 1 wherein the blade is substantially uniform in thickness, except for an upper camber which is greater in thickness than a lower camber.
